(19) United States
(12) Patent Application Publication
(10) Pub. No.: US 2025/0180694 A1
(43) Pub. Date: Jun. 5, 2025

(54) METHOD AND COMPUTER SYSTEM ADAPTED FOR ENHANCING RESOLUTIONS OF SYNTHETIC APERTURE RADAR (SAR) COLLECTIONS

(71) Applicant: JEFFREY S. PENNINGS, ANN ARBOR, MI (US)

(72) Inventor: JEFFREY S. PENNINGS, ANN ARBOR, MI (US)

(21) Appl. No.: 18/932,228

(22) Filed: Oct. 30, 2024

Related U.S. Application Data
(60) Provisional application No. 63/605,949, filed on Dec. 4, 2023.

(51) Int. Cl. G01S 7/295; G01S 13/90; G06T 3/4038; G06T 5/70

(52) U.S. Cl. CPC G01S 7/295; G01S 13/9011; G01S 13/9052; G06T 3/4038; G06T 5/70; G06T 2207/10044

(57) ABSTRACT

In a method and computer system for enhancing resolutions of synthetic aperture radar (SAR) collections across a large search area, each collection may be represented by raw phase history data collected across a scene of the search area., the raw phase history embodied as a plurality of pulses representative of image data. The method includes ingesting a plurality of pulses in the raw phase history from the collection, the plurality of pulses including clean pulses and additional lower quality noisy pulses that have a determined potential value as to stationary or dynamic information on the ground. The method further includes enhancing resolution of the ingested clean and additional lower quality noisy pulses to generate enhanced pulses, and cleaning the enhanced pulses to create a two-dimensional scene of complex, grayscale or colorized pixels in either slant coordinates or ground plane coordinates.

### CROSS-REFERENCE TO RELATED APPLICATION

The present application claims priority under 35 U.S.C 119 (e) to co-pending U.S. Provisional Patent Application Ser. No. 63/605,949 to the inventor, filed Dec. 4, 2023, the entire contents of which is hereby incorporated by reference herein.

### BACKGROUND

### Field

The example embodiments in general are directed to a method and computer system adapted for enhancing resolutions of synthetic aperture radar (SAR) collections.

### Related Art

A low Earth orbit (LEO) is, as the name suggests, an orbit that is relatively close to Earth's surface. It is normally at an altitude of less than 1000 km but could be as low as 160 km above Earth. This is low compared to other orbits (such as geosynchronous equatorial orbits (GEO), but still very far above Earth's surface.

Unlike satellites in GEO that must always orbit along Earth's equator, LEO satellites do not always have to follow a particular path around Earth in the same way; e.g., their plane can be tilted. This means there are more available routes for satellites in LEO. Coupled with LEO's close proximity to Earth, these are reasons why LEO is the most commonly used orbit for satellite imaging, as being near the surface allows a satellite to take images of higher resolution.

Today, imaging satellites in LEO monitor many features on the Earth's surface using synthetic aperture radar (SAR). In general, most if not all uses and applications of SAR data from various satellite constellations in LEO can be classified into very broad categories such as mapping and land classification, parameter retrieval, and object detection. Mapping and land classification tries to identify and classify the type of surface, on land, sea, or ice. Real world examples might include general applications of land monitoring (agriculture, deforestation, subsidence), maritime monitoring (sea ice, oil spills, ship activity, port activity, marine winds, etc.) and emergency response monitoring (flooding, volcanic, earthquake, etc.). Parameter retrieval consists of retrieving local parameters and information relating to the Earth, such as soil moisture and wind speed. The use or application of object detection aims at locating and identifying objects in SAR imagery. Hence, SAR imagery data may provide meaningful information about a number of human activities tied to the ecosystem, to agriculture, to economics, and to matters of national security, for example.

SAR is a microwave remote sensing technology that was first conceived in the early 1950s. Researchers discovered that synthesizing the antenna aperture of a side-looking radar mounted on an aircraft could improve angular resolution, and early airborne SAR systems were flown in the late 1950s. SAR technology has since seen rapid progress, with a variety of radar modes developed. The first spaceborne SAR mission, SEASAT, was launched in 1978, and followed by numerous missions of advanced SAR sensors providing fine resolution measurements useful in various disciplines.

SAR systems are operated from elevated places on land, and from manned and unmanned aircraft and spacecraft (such as the SENTINEL-1 and ICEYE satellite constellations in LEO). SAR can provide images on a 24-hour basis and in all kinds of weather and has the ability to penetrate clouds, fog, and in some cases, leaves, snow, and sand.

SENTINEL-1 was the first of the Copernicus Programme satellite constellation conducted by the European Space Agency (ESA) for satellite imaging of the Earth in the LEO using SAR. The mission was originally composed of a constellation of two satellites sharing the same orbital plane, Sentinel-1A and Sentinel-1B. Two more satellites, Sentinel-1C and Sentinel-1D are in development. Sentinel-1B has been retired, leaving Sentinel-1A the only satellite of the constellation. The SENTINEL-1 satellites carry a C-band SAR instrument enabling the collection of data in all-weather, day or night. The SENTINEL-1A satellite supports operational applications in the priority areas of marine monitoring, land monitoring and emergency services.

FIG. 1 is an illustration of traditional SAR acquisition modes. Traditionally, SAR systems had three basic modes of acquisition, stripmap, spotlight, and scanSAR modes (EW/IW modes). In general, in the stripmap mode the transmitter (antenna array) is fixed; therefore, the beam scans a swath parallel to the azimuth axis. In the scanSAR mode, the transmitter moves orthogonal to the azimuth direction and the swath will create zigzags on the ground. In this mode the scanned area is increased, but since the scan time is decreased the final resolution of the image product would be lower. In the spotlight mode, the transmitter moves in the direction of the azimuth axis to keep the beam focused on one location for as long as possible. In spotlight mode the scanned area is reduced considerably, but the since the scan time is increased, the resolution would be higher. The three SAR acquisition modes are shown in FIG. 1.

The SENTINEL-1A SAR satellite system may acquire data in four exclusive modes. The first is the Stripmap (SM) mode as noted above. SM mode is a standard SAR imaging mode where the ground swath is illuminated with a continuous sequence of pulses, while the antenna beam is pointing to a fixed azimuth and elevation angle. The second mode is Interferometric Wide swath (IW) mode. Here, data is acquired in three swaths using what is known as a Terrain Observation with Progressive Scanning SAR (TOPSAR) imaging technique. In IW mode, bursts (also known as “pulses”) are synchronized from pass to pass to ensure alignment of interferometric pairs. IW mode is SENTINEL-1's primary operational mode over land.

The third mode is Extra Wide swath (EW). In EW mode, imaging data is acquired in five swaths using the aforementioned TOPSAR imaging technique. EW mode provides a very large swath coverage at the expense of spatial resolution. TOPSAR thus enables the Extra Wide Swath (EW) and Interferometric Wide Swath (IW) modes and facilitates interferometric SAR. Interferometry uses more than one image of the same location to detect motion such as land deformation. Examples include studies of volcanoes, earthquakes, and sinkholes.

The TOPSAR mode is intended to replace the conventional ScanSAR mode original used for IW and EW modes, achieving the same coverage and resolution as ScanSAR, but with a nearly uniform Signal-to-Noise Ratio (SNR) and Distributed Target Ambiguity Ratio (DTAR). Also, azimuth resolution with TOPSAR mode is reduced compared to ScanSAR mode due to the shorter target illumination time of the burst.

The fourth mode is the Wave (WV) mode. In the WV mode, imaging data is acquired in small stripmap scenes known as “vignettes”, situated at regular intervals of 100 km along a track. The vignettes are acquired by an alternating sequence, namely acquiring one vignette at a near range incidence angle, while the next vignette is acquired at a far range incidence angle. WV is SENTINEL-1A's operational mode over open ocean.

Today, over 40 commercial SAR satellites offering imaging data products are in LEO, with each having a common superpower, that being the aforementioned ability of seeing through clouds. One of these is the ICEYE constellation. As previously noted, spaceborne Earth observation has been well established for decades, with SAR satellites as the gold standard due to their ability to collect images from areas of interest day and night and in any weather. Traditional SAR satellites such as SENTINEL-1A are very large and carry very large antennas with limited revisit frequency and flexibility.

ICEYE's small and agile SAR satellites are able to revisit the same location on Earth daily and even sub-daily, enabling a completely new level of change detection. ICEYE's large commercial constellation of 20 SAR satellites now makes it possible for governments and commercial organizations to acquire data on any location on Earth, any time they need it, with very high resolution, high frequency revisits, and at an affordable price.

The ICEYE antenna is designed to enable a wide range of operational approaches, with Spot, Strip, Scan and Dwell modes. These modes provide the ability to shift between scanning areas up to 50,000 km² in area in lower resolution, to zooming into areas at much higher resolution, such as imaging 50 cm resolution in Spot Fine mode, which enables one to detect and classify objects like vehicles and vessels. With the world's largest SAR constellation, ICEYE delivers unlimited global access and the highest frequency revisits on the SAR imagery data market, measured in hours instead of days, and have already provided 40,000+ images to government and commercial clients across the globe.

Moreover, utilizing ICEYE change detection techniques, it is possible to identify highly accurate ground change every 24 hours, including things like movement of a vehicle along a track or lava flow during a volcano eruption. Each image in a stack has the exact same geometry, radiance and phase, which enables millimeter-level change detection.

The ability of a SAR-based satellite constellation to see through clouds enables something much more profound in the world of situational monitoring, that being the ability to achieve measurement repeatability in SAR imaging data. FIG. 2 shows an unlabeled scatter plot. Each dot represents a collection in time within an area scene that a radar can make (e.g., each dot actually represents anything of interest within the scene). FIG. 2 is provided to emphasize that optical images can't penetrate the scene when there is cloudy or bad weather. But with a SAR system, one can control when they observe the scene (weather unaffected). Hence, the SAR system is not linked or limited by any environmental influences in order to obtain imagery data.

However, in the current commercial space-based SAR market, cost is prohibitive. Satellite radar data at sufficient resolution to observe temporal dynamic change (such as movement of trucks, ships, and trains on the ground within the search area) is simply too expensive to support extensive high revisit global data products. For example, a conventional pricing model today for satellite vendors to receive SAR image data at 3000 locations refreshed weekly, for 52 weeks, would be a $78,000,000 annual cost.

What this means is that very few multi-user products are able to support this burn rate in order to meet budget or secure any profit. Said another way, the promise of SAR simply cannot be realized with these economies, with few viable commercial customers consumers due to this prohibitive cost. Essentially, full use of SAR data (TOPSAR and ScanSAR data) is cost-limited to only those national governments having sufficient budgets for acquiring and analyzing this SAR data.

Typically, when a radar collector executes a large search area collection (area greater than the instantaneous 3 dB antenna footprint of a SAR satellite) to get a wider or large area covered, the radar collector will need to accept loss in resolution of ground features within that large area scene. Hence, the trade-off in accumulating a collection in a large field of view (large search area) is resolution loss. In other words, when executing a large or wide area collection, the resultant pixel quality is not sufficiently detailed so as to detect any dynamic changes on the ground (such as ground vehicles, ground equipment, etc.). Accordingly, this means that conventional radar collectors must trade a desire for greater wide area coverage at the cost of reduced or less dynamic information. This is because none of the conventional collection techniques include noisy pulses off the peak of the antenna main lobe and in the antenna sidelobes in order to enhance signal data for a final image product to the consumer. Instead, the primary (noise-free) pulses of the main lobe are processed, and any noisy pulses off the peak of antenna beam is typically removed during processing. Hence, there is no accounting for pulses with noise that might have some positive influence on final image quality.

What is needed is some process or system which effectively allows a radar collector to collect image data in a large search area collection scene, but still provides an ability to process dynamic information as well as stationary information on the ground that is accessible within that large area scene of the collection. Such a realization would substantially reduce costs to commercial and government satellite vendors alike.

### SUMMARY

An example embodiment of the present invention is directed to a method executed by one or more computing devices in a satellite orbiting the earth for enhancing resolutions of synthetic aperture radar (SAR) collections across a large search area. Each collection within the large search area is represented by raw phase history data collected across a defined scene within the large search area. The raw phase history data is embodied as a plurality of bursts, each burst containing multiple pulses representative of pixel image data. The method may include ingesting a plurality of bursts in the raw phase history collected across each defined scene within the large search area, each ingested burst having a plurality of pulses including clean pulses, and having additional lower quality noisy pulses offering a determined potential value as to dynamic and stationary information on the ground. The method further may include enhancing resolution of the ingested bursts of clean and additional lower quality noisy pulses to generate enhanced bursts, and then cleaning the enhanced bursts to create a two-dimensional (2D) mosaic scene. The ingesting, enhancing, and cleaning steps are performed by computer software adapted to run on computer hardware of the one or more computing devices.

Another example embodiment is directed to a method for enhancing resolutions of synthetic aperture radar (SAR) collections across a large search area. Each collection within the large search area is represented by raw phase history data collected across a defined scene within the large search area. The raw phase history data is embodied as a plurality of bursts, each burst containing multiple pulses of pixel image data. The method may include applying a sliding polar format algorithm to each of the plurality of bursts to create polar format grids, each burst having a plurality of pulses including clean pulses, and having additional lower quality noisy pulses identified in the algorithm as having useful data to enhance image quality. The method further may include subjecting the created polar format grids to a windowing function on a pixel-by-pixel basis to generate enhanced bursts, and then cleaning the enhanced bursts to create a final imaging product for a consumer with enhanced resolution.

Another example embodiment is directed to a computer system adapted for enhancing resolutions of synthetic aperture radar (SAR) collections across a large search area. Each collection within the large search area is represented by raw phase history data collected across a defined scene within the large search area, with the raw phase history data embodied as a plurality of bursts. Each burst contains multiple pulses representative of pixel image data. The computer system may include a processing hardware set, and a computer-readable storage device medium, wherein the processing hardware set is structured, connected and/or programmed to run program instructions stored on the computer-readable storage medium instructions and associated data. The program instructions may include an ingestion module programmed to ingest a plurality of bursts in the raw phase history collected across each defined scene within the large search area, each ingested burst having a plurality of pulses including clean pulses, and having additional lower quality noisy pulses having data determined therein useful for enhancing image quality of a final imaging product to be realized. The program instructions may further include an enhancement module programmed to enhance resolution of the ingested bursts of clean and additional lower quality noisy pulses to generate enhanced bursts, and a cleaning module programmed to clean the enhanced pulses to create a two-dimensional (2D) mosaic scene as the final imaging product for a consumer. The computer system includes a database for storing the created 2D mosaic scene.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is an illustration of traditional SAR acquisition modes.

FIG. 2 shows an unlabeled scatter plot as a function of data range to explain the concept of measurement repeatability.

FIG. 3 is a basic flow diagram of for enhancing resolutions of synthetic aperture radar (SAR) collections according to the example embodiments.

FIG. 4 is a flow diagram showing the additional sub-processing steps included in the resolution enhancing step of FIG. 3 to generate enhanced bursts.

FIG. 5 is a flow diagram showing the additional sub-processing steps included in the cleaning step of FIG. 3.

FIG. 6 is a pictorial representation to describe a first sub-process executed in the resolution enhancing step shown in FIG. 4 in further detail.

FIG. 7 is a pictorial representation to describe a second sub-process executed in the resolution enhancing step of FIG. 3 in further detail.

FIG. 8 is a pictorial representation to describe a third sub-process executed in the resolution enhancing step of FIG. 3 in further detail.

FIG. 9 is a pictorial representation to describe a fourth sub-process executed in the resolution enhancing step of FIG. 3 in further detail.

FIG. 10 is a pictorial representation to describe a fifth sub-process executed in the resolution enhancing step of FIG. 3 in further detail.

FIG. 11 is a pictorial representation to describe a deskew sub-process executed as part of the cleaning step of FIGS. 3 and 5.

FIG. 12 is a pictorial representation to describe a mosaic creation sub-process executed as part of the cleaning step of FIGS. 3 and 5 to realize the final image product.

FIG. 13A is a Ground Range Detected (GRD) image of the White House and surrounding area in Washington, DC formed using traditional processing acquired from the Alaska Data Facility Vertex Data Portal.

FIG. 13B is the same image as in FIG. 13A, but after using the new processing according to the example embodiments.

FIG. 14 is a screenshot of Google Earth basemap imagery showing the port of Santos in Sao Paolo overlaid with a typical SENTINEL-1 IW mode collection boundary, to compare costs for acquiring and image data from two different search areas scenes of comparable size using traditional processing and the new processing according to the example embodiments.

FIG. 15 is a block diagram of an exemplary computer system and/or computing device for implementing the example method.

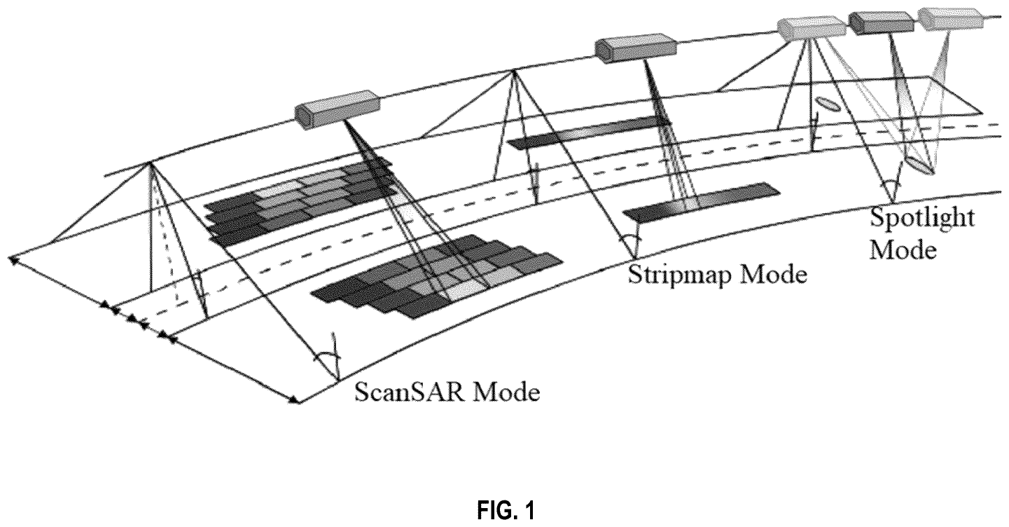

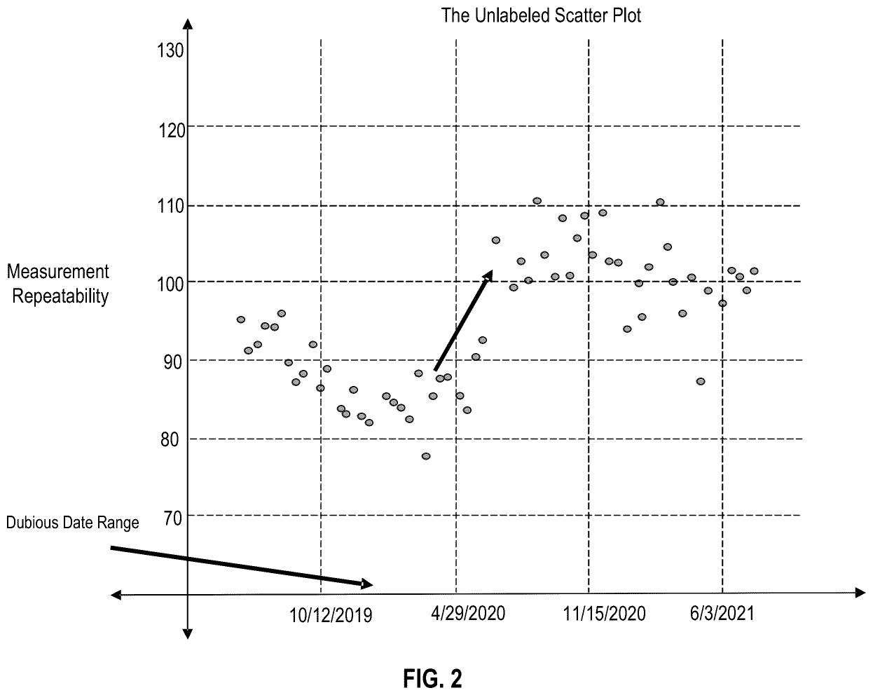

### DETAILED DESCRIPTION

The example method and system addresses the aforementioned problems with cost. Namely the method and system provides a way to enhance these large area/coarse resolution of SAR data from IW, EW, or Scan and ScanSAR collections. The processing architecture of the system is able to continue to process the large search area scene of a collection but still make dynamic information (such as ground vehicles or ground equipment and the like) accessible within the large area scene.

As defined herein, the phrase “large search area” within a SAR collection is any area that is bigger than the instantaneous 3 dB antenna footprint of a SAR satellite, as is known. Collecting a large search area requires the action of moving the antenna over the ground during the collection in order to illuminate the large (larger) search area and processing the antenna motion into a single contiguous image.

The example method and system thus provides an ability to do image processing of typical immovable large objects within a large search area scene, but also provides improved pixel processing at the back end. This processing is done in such a way as to provide a more robust resolution to see dynamic content or things that change all the time, such as moving vehicles, containers, equipment, and the like. Hence, the example method and system may provide a much more accurate change detection capability within a typical large area collection that conventionally requires much higher and more costly resolution modes, e.g., Spot mode in an ICEYE satellite.

Further and as will be seen below, the example method applies a sliding polar format algorithm to each of the plurality of bursts that make up the raw phase history of the large search area scene to create polar format grids of pixels. These polar format grids are subjected to a windowing function on a pixel-by-pixel basis to generate enhanced bursts, whereby the enhanced bursts are then cleaned to create a final imaging product (such as a 2D mosaic scene) for a consumer with enhanced resolution.

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Additionally, a “computer system” or “computing device” as used hereafter encompasses any of a smart device, a firewall, a router, and a network such as a LAN/WAN. As used herein, a “smart device” or “smart electronic device” is an electronic device, generally connected to other devices or networks via different wireless protocols such as Bluetooth, NFC, WiFi, 3G, 4G, 5G, etc., that can operate to some extent interactively and autonomously. Smart devices include but are not limited to smartphones, PCs, laptops, phablets and tablets, smartwatches, smart bands and smart key chains. A smart device can also refer to a ubiquitous computing device that exhibits some properties of ubiquitous computing including—although not necessarily—artificial intelligence. Smart devices can be designed to support a variety of form factors, a range of properties pertaining to ubiquitous computing and to be used in three primary system environments: physical world, human-centered environments, and distributed computing environments.

As used herein, the term “cloud” or phrase “cloud computing” means storing and accessing data and programs over the Internet instead of a computing device's hard drive. The cloud is a metaphor for the Internet.

Further, and as used herein, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, any kind of database object described herein can be implemented as single databases, a distributed database, a collection of distributed databases, a database with redundant online or offline backups or other redundancies, etc., and might include a distributed database or storage network and associated processing intelligence.

The computer system(s), computing device(s), method(s), computer program product(s) and the like, as described in the following example embodiments, may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means or the like. In general, any device(s) or means capable of implementing the methodology illustrated herein can be used to implement the various aspects of the example embodiments.

Computer program code for carrying out operations for aspects or embodiments of the present invention may be written in any combination of one or more programming languages, including a programming language such as JAVASCRIPT®, JAVA®, SQL™, PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computing device, partly on the user's computing device, as a stand-alone software package, partly on the user's computing device and partly on a remote computer or entirely on the remote computer or server. In the latter scenario, the remote computer may be connected to the user's computing device through any type of network, including a LAN or WAN, or the connection may be made to an external computer (for example, through the Internet using an Internet Service Provider).

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

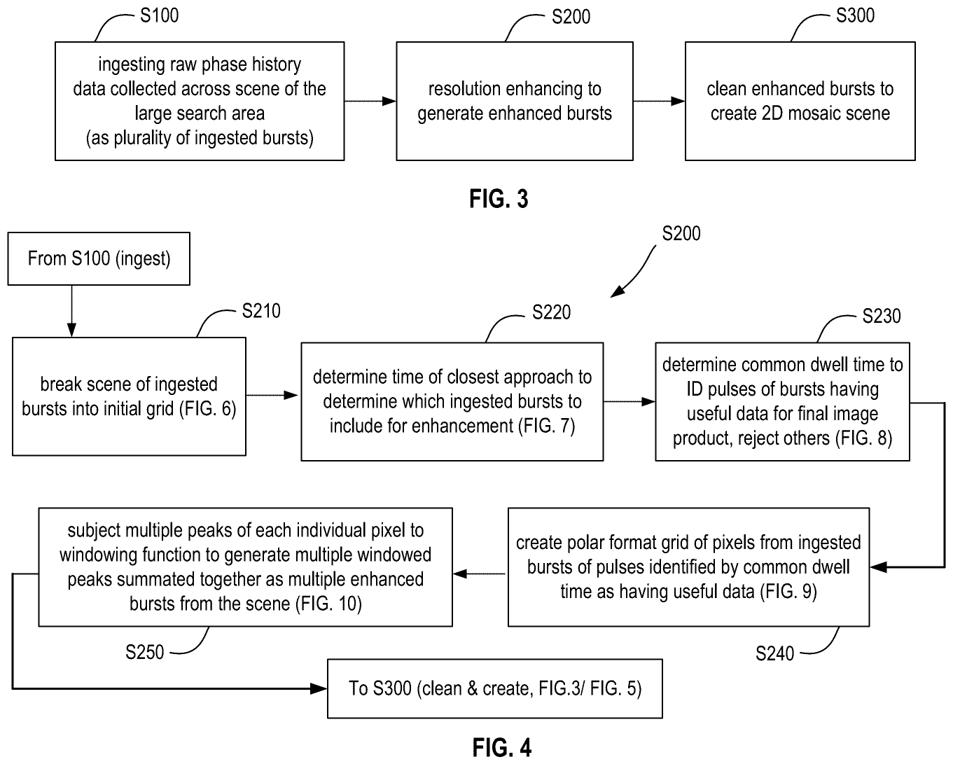

FIG. 3 is a basic flow diagram of for enhancing resolutions of synthetic aperture radar (SAR) collections according to the example embodiments. The example method described hereafter is executed by one or more computing devices in a satellite orbiting the earth for enhancing resolutions of synthetic aperture radar (SAR) collections across a large search area. Each collection within the large search area is represented by raw phase history data collected across a defined scene within the large search area. The raw phase history data is embodied as a plurality of bursts, each burst containing multiple pulses (pulse signals) representative of pixel image data.

The example method and system collect image data over ultra-large areas of SAR imaging data (TOPSAR and ScanSAR data that are typically representative of these large search area collections) that cover common areas of interest. However, the system only stores raw TOPSAR and/or ScanSAR phase history data to conserve processing and storage expense. TOPSAR and/or ScanSAR phase history data are represented as a plurality of digital signals, namely a plurality of bursts also called pulses or pulse signals), as is known.

For the example method of FIG. 3 raw phase history (raw phase history is level LO data) collected across each defined scene within the large search area is ingested (Step S100, as a plurality of bursts). Each ingested burst is composed of a plurality of pulses including clean pulses representative of dynamic and/or stationary information in the ground, and including additional lower quality noisy pulses which also offer a determined potential value as to the dynamic and stationary information on the ground. A clean pulse as understood herein is a pulse where the expected signal power is greater than the expected noise power (greater than 0 db). These additional lower quality noisy pulses as described herein are pulses where the expected signal power is lower than the expected noise power (SNR of 0 dB). So in addition to processing these clean pulses (as done conventionally), the example method and system also use and process these additional lower quality noisy pulses, as will be described hereafter. Not all bursts contain clean pulses. The burst with the highest quality pulses is called a primary burst and all additional lower-quality noisy bursts are called secondary bursts.

These plurality of ingested bursts are subjected to a resolution enhancing process (Step S200) that enhances resolution of the ingested bursts of clean and additional lower quality noisy pulses to generate enhanced bursts. The enhanced bursts are then cleaned (Step S300) to create a two-dimensional (2D) mosaic scene as a final image product for a consumer. The ingesting, enhancing, and cleaning steps are performed by computer software adapted to run on computer hardware of the one or more computing devices.

Generally, a conventional image processor in a SAR processing system processes only those high pulses or pulse signals in the primary burst, i.e., those bursts collected in the large area scene which have minimal noise and are hence “clean” pulses. The example method and system processes all of these premium clean pulses as well. However, additional pulses are processed for cleaning and conversion into pixel product. Namely, all pulses across the large area collection which offer some or any potential value as to stationary or dynamic target information on the ground are also subject to the cleaning algorithm. The example method and system process at least eighty times (80×) more pulses for a given SENTINEL-1A IW collection than conventional technologies; hence additional processing time is required. Certain ones of these additional bursts or pulses (those lower quality pulses in the sidelobes determined by the algorithm to have some value as to stationary or dynamic ground content in the scene) are, along with the premium bursts, ultimately processed into a two-dimensional mosaic scene represented by a pixel product (final image product).

Said another way, for the the example method and system, at least 98% of all pulses in a given burst, including all clean and all selected noisy pulses, are subject to processing for enhancement in creating the 2D mosaic as the final imaging or pixel product. So as each burst is a sequence of pulses including primary clean pulses and secondary pulses with noise, at least eight (8) bursts or 80× the number of pulses used by a conventional collector in a SAR system are subject to processing according to the example method and system for enhancing resolution in creating the 2D mosaic as the final imaging product. Accordingly, the example method and system process not only perfect or premium pulse signals from a collected large area scene, but all such pulse signals that may be determined by the algorithm as offering any potential value as to extra stationary or dynamic content (higher resolution of dynamic features on the ground), within the collected large area scene.

In an example, the created 2D mosaic scene can be a scene of complex pixels in either slant coordinates or ground plane coordinates. In another example, the 2D mosaic scene is a seamless scene of grayscale pixels in either slant coordinates or ground plane coordinates. In a further example, the 2D mosaic scene is a seamless scene of colorized pixels in either slant coordinates or ground plane coordinates.

FIG. 4 is a flow diagram showing the additional sub-processing steps included in the resolution enhancing step S200 of FIG. 3 to generate enhanced bursts. Referring to FIG. 4, the step of enhancing resolution of the ingested bursts involves a series of sub-processes to be executed by the computing device(s). The defined scene of ingested bursts of clean and additional lower quality noisy pulses is initially broken into an initial grid (Step S210). As will be discussed in FIG. 6 in more detail, the initial grid is embodied by a plurality of overlapping circles, each circle representative of an edge of a conical section of a sphere within the scene to form a localized spherical coordinate system. Each circle has a centerpoint that is unique from centerpoints of the other circles.

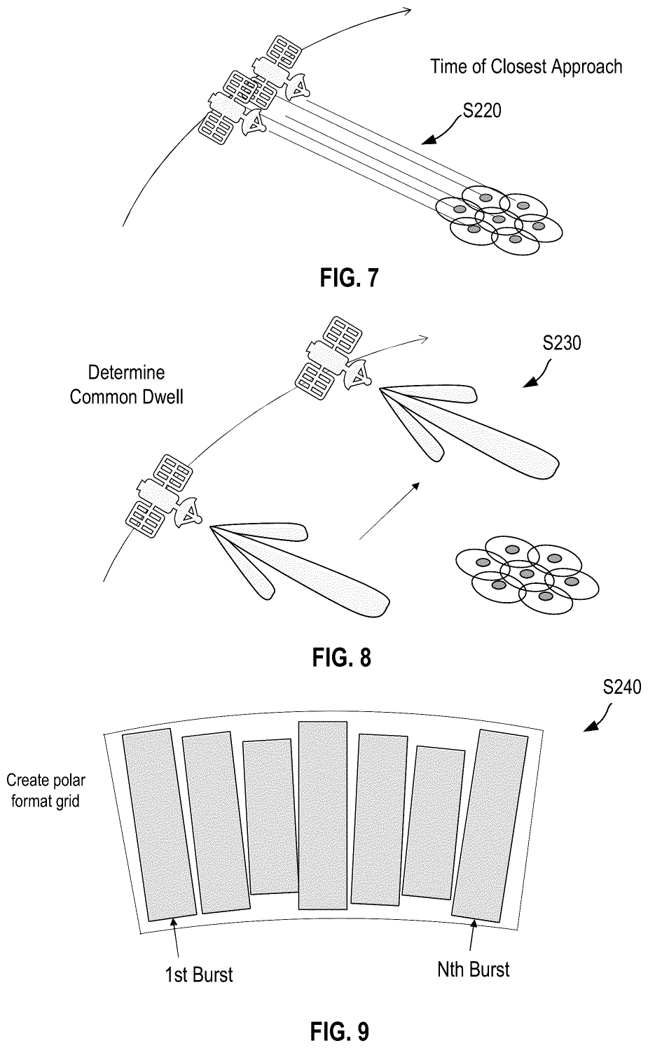

For the initiated grid created in Step S210, a point closest to the center of the earth that is equidistant to every centerpoint in each circle is found, as to be described in further detail with regard to FIG. 7. This point is used to determine a time of closest approach (TCA). The TCA is used to determine which of the ingested bursts of clean and additional lower quality noisy pulses to include for pixel processing to realize enhanced resolution.

Next, based on the TCA, a common dwell time is determined (Step S230) to identify those ingested bursts that contribute useful data to enhance image quality, based on a search pattern of the antenna, for a final imaging product that is to be realized as the 2D mosaic scene. As will be described in more detail regarding FIG. 8, any pulses within an ingested burst that are determined as having no useful data are rejected. The determined common dwell time is the same for every pixel to be processed.

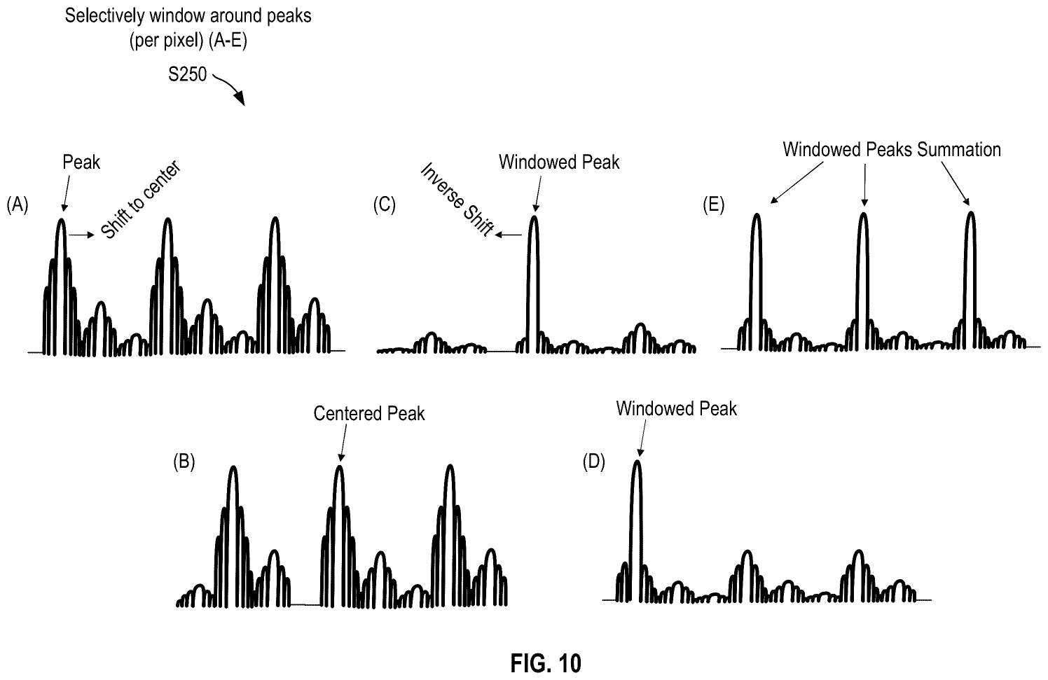

Once the common dwell time is determined and certain pulses with noise rejected, a polar format grid of pixels is created (Step S240). As described in more detail hereafter regrading FIG. 9, this polar grid of pixels is created in the frequency domain from the ingested bursts of clean and additional lower quality noisy pulses identified from the common dwell time as having useful data to enhance image quality. For the created polar format grid, each individual pixel thereof is subject to a windowing process (Step S250). Namely, and as described in detail referencing FIG. 10 hereafter, each individual pixel of the polar format grid is subject to a windowing function, whereby each pixel has multiple dominant peaks that are subject to dynamic weighting in the windowing function. This dynamic weighting generates multiple, individual windowed peaks in which unneeded noise signal data has been removed, while clarity of the signal data therein is improved. The multiple windowed peaks for each individual pixel are then summated together as multiple enhanced bursts from the defined scene in preparation for the cleaning process (Step S300).

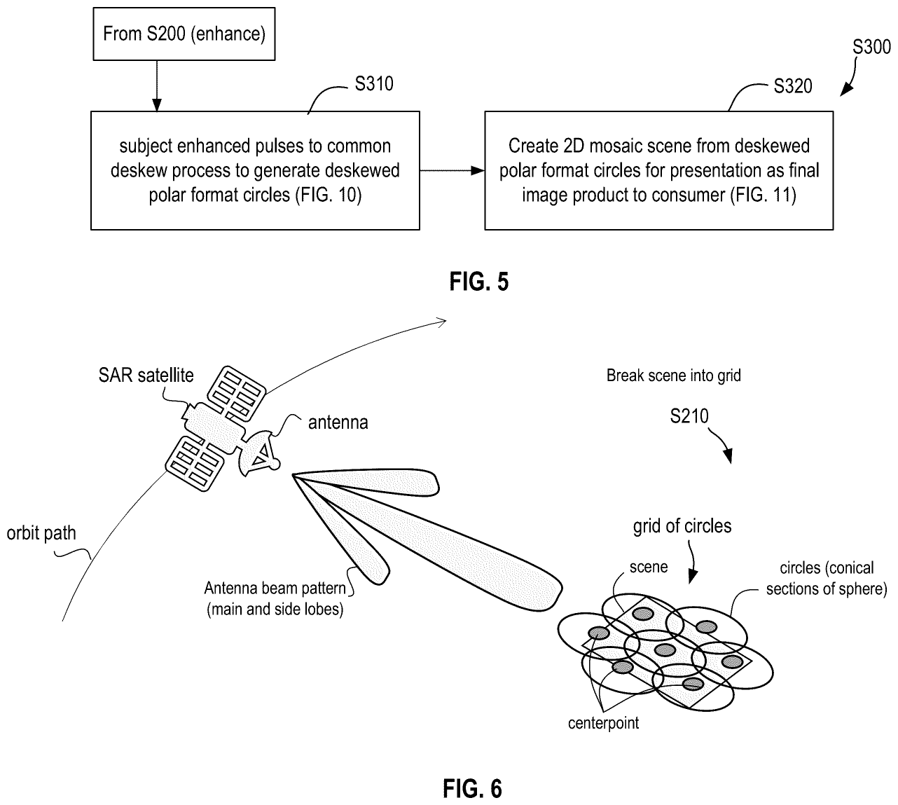

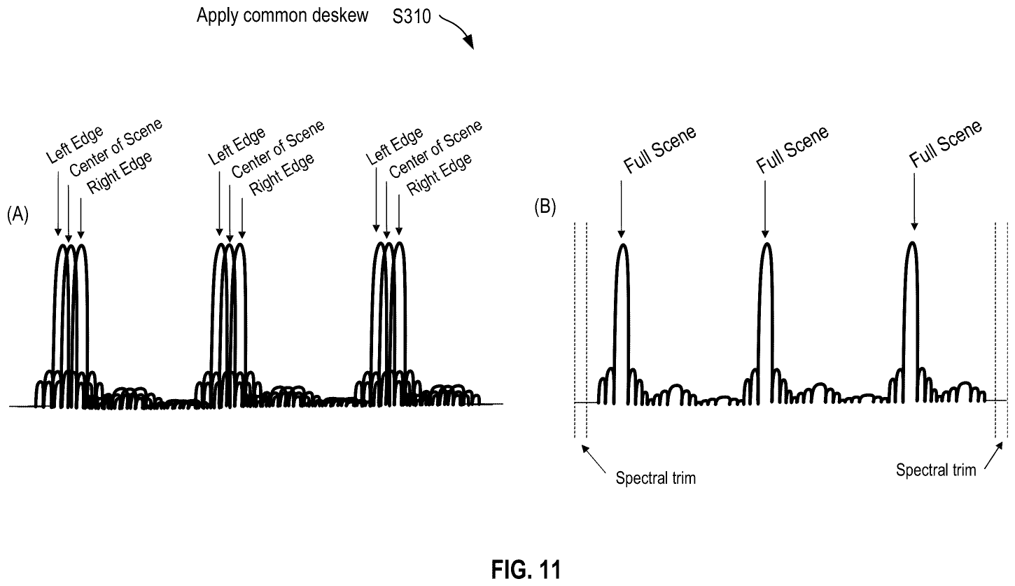

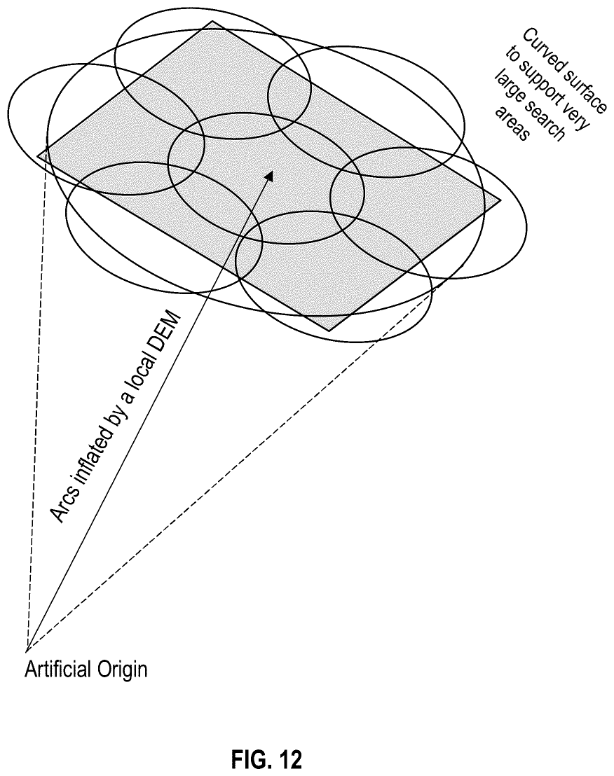

FIG. 5 is a flow diagram showing the additional sub-processing steps included in the cleaning step of FIG. 3. Referring to FIG. 5, for the cleaning step S300, the multiple enhanced bursts (pulses) from the defined scene resultant from the windowing function are subject to a common deskew process to generate deskewed polar format circles (Step S310); this deskew process is described in more detail in FIG. 11. The 2D mosaic scene is then created (Step S320) from the deskewed polar format circles as the final image (pixel) product to the consumer. This is described in more detail hereafter regarding FIG. 12.

FIG. 6 is a pictorial representation to describe the creation of the initial grid (Step S210) sub-process in the resolution enhancing step as shown in FIG. 4 in further detail. Referring to FIG. 6, there is shown a partial orbiting path of a SAR satellite with antenna and antenna beam pattern (main and side lobes) radiating a large search area to collect image pixel data from a defined scene (shown by the rectangle) in a large search area.

Recall that the defined scene of ingested bursts of clean and additional lower quality noisy pulses is initially broken into an initial grid (Step S210), the grid represented as a plurality of overlapping circles, each circle representative of an edge of a conical section of a sphere within the scene to form a localized spherical coordinate system. Each conical circle has a centerpoint that is unique from centerpoints of the other circles. This is a beginning step to forming the polar format grid discussed hereafter in the process.

The reason each circle is defined as an edge of a conical section of a sphere is to account for the curved surface of the earth. As the image processing presumes rectangular shapes on earth, but the earth is curved, conical or spherical coordinates are used in order to process a large search area. Breaking the scene of bursts into conical systems offer a localized coordinate system that is easy to use and very accurate, hence “easy bookkeeping for processing”.

FIG. 7 is a pictorial representation to describe TCA determination in Step S220 in further detail. Recall that each circle has a centerpoint, with each centerpoint being unique for each circle. These centerpoints are necessary for defining the Time of Closest Approach (TCA) in Step S220. The key here is to find a unique time value (TCA) which is done by determining a point closest to the center of the earth that is equidistant to every centerpoint in every conical circle of the grid. The TCA is used to determine which pulses to include (or exclude) for processing each pixel of the defined scene, where each processed pixel will be subject to a windowing function described hereafter. Said a different way, the TCA enables the determination of which of the ingested bursts of clean and additional lower quality noisy pulses to include for pixel processing to realize enhanced resolution. This is important as it makes it easier to create the 2D mosaic at the end because each pixel was formed from the same pulse (and burst) content regardless of the polar format circle with which it was processed.

FIG. 8 is a pictorial representation to describe determining common dwell time for all pixels (Step S230) in further detail. Recall that based on the TCA, a common dwell time is determined to identify those ingested bursts that contribute useful data to enhance image quality, based on a search pattern of the antenna, for a final imaging product that is to be realized as the 2D mosaic scene. Said another way, the common dwell time determination helps to identify pulses (clean and those having noise) of the bursts that will contribute to better image quality, based on the antenna pattern; an example pattern shown in FIG. 8.

The common dwell time is determined for the pixel that has the longest dwell. This would be the pixel that has the highest number of pulses (clean primary and secondary with noise) that will constructively contribute to the final imagery (the 2D mosaic). This is determined in part based on theoretical antenna power. A common dwell time is included for only those pixels useful for forming the final image product; those with no useful information are discarded/rejected. Thus, the common dwell time is the same for every pixel to be processed. Recall from above that each burst is a sequence of pulses including primary or clean pulses and additional or secondary lower quality pulses with noise. According to the example method and system, a range of at least between 2 and 20 bursts are subject to processing for enhancing resolution in creating the final imaging product, which increases a common dwell determined for a sequence of pulses to be about 10× to 80× as compared to the common dwell time used in a conventional collector in a SAR system.

FIG. 9 is a pictorial representation to describe creating the polar format grids in Step S240 of FIG. 4 in more detail. As the common dwell time has been determined (and is the same) for every pixel to be processed, this means that all pulses used to create the polar format grid(s) are from all the bursts that have been determined to constructively contribute to better image quality, based on the antenna pattern (see FIG. 8). Burst is unique to TOPSAR/ScanSAR systems, with each burst being a sequence of pulses illuminating a common geographical are (scene) within a large beam area collector (antenna). But in these systems, and for each burst, the conventional processing (in which they use range migration for burst processing) of the collector uses less than 2% of the total pulses within the burst to define a target for acquisition and analysis. Here, in the example embodiment, at least 10% of the total number of pulses in a given burst that defines a target for acquisition, including all clean pulses and selected additional lower-quality noisy pulses therein, are subject to processing for enhancement in creating the 2D mosaic as the final imaging product.

Accordingly, in the example embodiment, 8 bursts (or 80 times the number of pulses that a common or conventional SAR collector uses for processing) are employed. No other data processing system does multi-burst processing on TOPSAR (IW or EW Mode) data; hence no other processing system creates a polar grid of pixels in the frequency domain from the ingested bursts of clean and additional lower quality noisy pulses identified from the common dwell time as having useful data to enhance image quality.

FIG. 10 is a pictorial representation to describe the windowing sub-process S250 executed in the resolution enhancing step S200 in further detail. Recall that enhancing resolution to generate enhanced bursts further includes subjecting, to a windowing function, those bursts of clean and ingested additional lower quality noisy pulses determined to contain useful data (such as dynamic and static information on the ground) for enhancing image quality, based on a search pattern of an antenna/determination of common dwell time. The windowing function processes these ingested bursts on a pixel-by-pixel basis to generate enhanced bursts. FIG. 10 shows this in the frequency domain in great detail. Referring to FIG. 10, windowing is applied to each pixel individually in the polar format grid. Waveform A represents a theoretical beam pattern of a single pixel form the FFT (Fast Fourier Transform) of the a polar format grid. Each pixel has multiple dominant peaks that need to be windowed, and each pixel has a unique FFT of an image that is to be windowed around. Waveform A shows that the windowing begins with applying a liner phase shift in the frequency domain to move the data to the center, see in Waveform B the centered peak resultant from the linear phase shift.

In Waveform C, the Waveform B with centered peak has been subject to weighting to create a windowed peak. The secondary pulses in Waveform C are pushed down just far enough to remove the artifacts (noise) while still improving the clarity of the signal data. The windowed peak in Waveform C is then subject to a linear inverse phase shift to realize Waveform D, where the windowed peak is shifted back to its original location. Waveform D applies to all peaks that constructively contribute to image quality of the final image product of the scene. Waveform E shows the summation of all windowed peaks, essentially optimizing all pixels to keep resolution up. This summation is run for each large windowed peak. Waveform E is what the complex data representative of the enhanced pulses looks like after FFT and windowing processing; these enhanced bursts prepared for the cleaning process.

Accordingly, FIG. 10 shows the individual sub-processing that each individual pixel of the polar format grid is subject to in a windowing function, whereby each pixel has multiple dominant peaks that are subject to dynamic weighting in the windowing function. This dynamic weighting generates multiple, individual windowed peaks in which unneeded noise signal data has been removed, while clarity of the signal data therein is improved. The multiple windowed peaks for each individual pixel are then summated together as multiple enhanced bursts from the defined scene in preparation for the cleaning process.

FIG. 11 is a pictorial representation to describe a deskew sub-process S310 executed as part of the cleaning step S300 of FIGS. 3 and 5; FIG. 12 is a pictorial representation to describe the mosaic creation sub-process to realize the final image product. Referring to FIG. 11, the pulse curves in Waveform A represent three (3) different pixels within a scene (each perhaps within different polar formatted conical circles of the defined scene) (there being thousands of pixels in a scene). Each pixel needs to be deskewed when processing a moving antenna in a polar format. Waveform B shows the pulses after deskewing in order to make a seamless full scene. What deskewing does is to ensure that every pixel in a given conical circle has the exact same number of pulses; this is required in order to realize the seamless 2D mosaic of FIG. 12

FIG. 12 pictorially represents how the 2D mosaic is created from the deskewed polar format circles for presentation as a final image product to the consumer. Spherical processing prevents geometric distortion at the center of the final image when using four-corners approximation. Here, each polar format circle is stitched back together to create a larger circle, and the 2D mosaic is created within the spherical coordinates. This ground projection is performed using a standard polar format slant to ground projection. Each pixel represents a coordinate form the original slant plane and the pixel data is projected into the common mosaic format, and then resampled to contribute to the 2D final mosaic, as is known.

The artificial origin in FIG. 12 represents the point nearest the center of the earth. The arcs inflated by a local Digital Elevation Model (DEM) means that the pixel data is orthorectified for presentation as delivered image output to the consumer, a well-known delivered output image being an image in a Google Earth image format.

The example method and system take advantage of its unique processing of raw phase history to save money for vendors or consumers. Namely, where the SAR satellite is staring at many more targets of potential interest in a given period of time, the example method and system can utilize the same resources to collect, process and provide a polished pixel output for a substantially larger area.

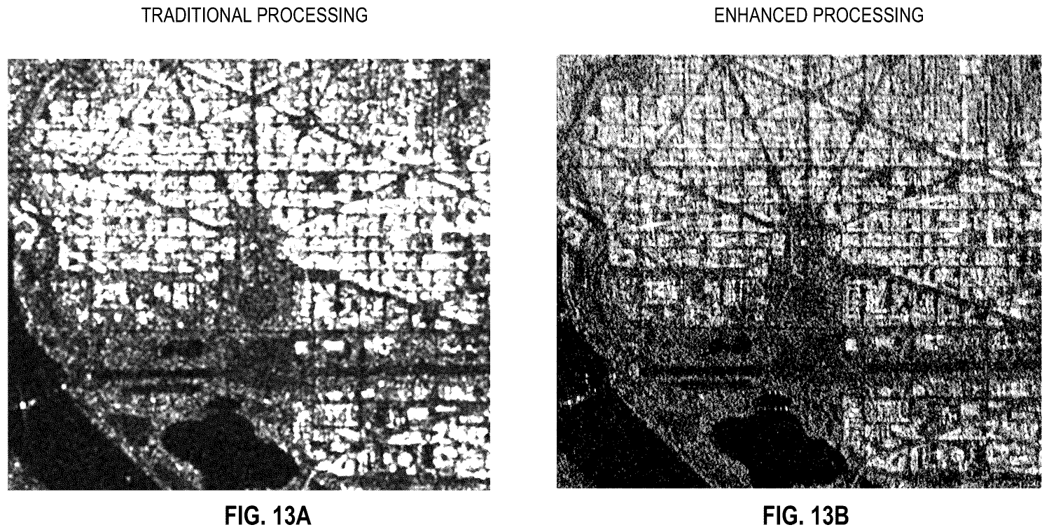

FIG. 13A is a GRD image (via the Alaska Data Facility Vertex service) of the White House and surrounding area in Washington, DC using traditional processing, and FIG. 13B is the same image as in FIG. 13A, but show a final image product using the new processing according to the example embodiments. Notice the total lack of clarity in FIG. 13A in this large area scene. There is no possibility of being able to assess any dynamic movement on the ground due to what is known as “blubby pixels”. However, with Applicant's new processing in FIG. 13B, its algorithms are able to take these blubby pixels of the large area scene and make them much sharper, so as to contain more detail for assessment of both stationary and dynamic ground information (e.g., non-stationary vehicles on roads around the White House).

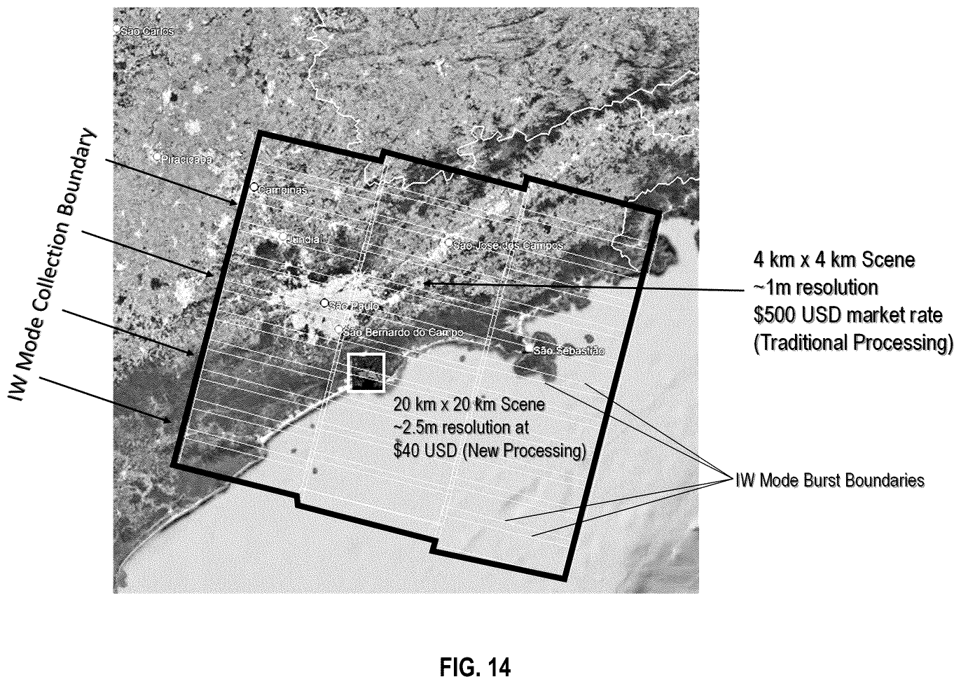

FIG. 14 is a typical RTC processed image from Microsoft Planetary Computer showing the port of Santos in Sao Paolo overlaid with a typical SENTINEL-1 IW mode collection boundary, to compare costs for acquiring and image data from two different search areas scenes of comparable size using traditional processing and the new processing according to the example embodiments. Specifically, FIG. 13 shows a typical SENTINEL-1 high range collection boundary (thicker border) and interior IW mode burst boundaries within the scene (thin lines denoting adjacent burst boundaries).

Within the collection there are shown two different sized search areas or scenes. One search area is a 400 km² scene (large area scene) at 2.5 m resolution with cost information associated therewith with using the new processing for enhancing SAR collections according to the example embodiment. The second search area is a smaller but higher 1.0 m resolution image scene that is 16 km², along with its associated cost information, this search area subject to traditional processing for SAR collections. This second search area is a typical spotlight hi-resolution collection size. As FIG. 14 shows, conventional cost (market rate) for a final image product from the spotlight mode hi-resolution smaller scene is $500 USD. Conversely, in light of the example method and system, the final image product cost from a collection in a larger scene area, which can provide additional dynamic content on the ground (similar to a spotlight mode image associated with the 1.0 m resolution), can be executed at a much lower cost rate of $40 USD. The 2.5 m pixel resolution with image enhancement almost approximates the quality of the 1.0 m spotlight mode at a 10×+ reduction in cost per image product. Accordingly, a 2D mosaic scene (final image product) can be created by the example method at a resolution approximating that final image product obtained using a SAR system in high-resolution spotlight mode, but processed (and hence sold) at a fraction of the cost typical for high resolution image product from SAR systems.

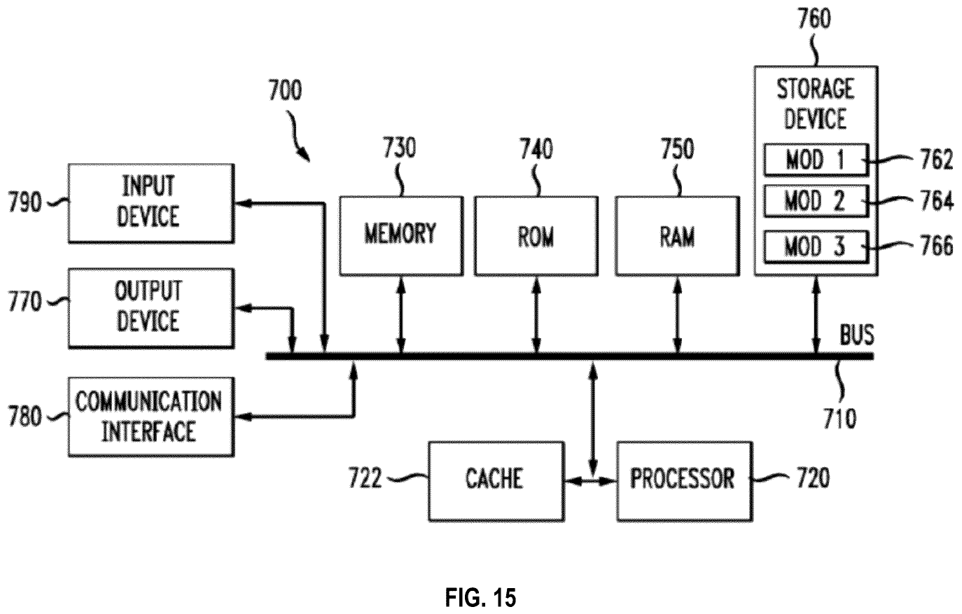

FIG. 15 is a block diagram of an exemplary computer system and/or computing device for implementing the example method. Namely, a description of a basic general-purpose computer system or computing device in FIG. 15 can be employed to practice the concepts, methods, and techniques disclosed. With reference to FIG. 15, an exemplary computer system and/or computing device 700 includes a processing unit (CPU or processor) 720 and a system bus 710 that couples various system components including the system memory 730 such as read only memory (ROM) 740 and random-access memory (RAM) 750 to the processor 720. The system 700 can include a cache 722 of high-speed memory connected directly with, in close proximity to, or integrated as part of the processor 720.

The system 700 copies data from the memory 730 and/or the storage device 760 to the cache 722 for quick access by the processor 720. In this way, the cache 722 provides a performance boost that avoids processor 720 delays while waiting for data. These and other modules can control or be configured to control the processor 720 to perform various operations or actions.

Other system memory 730 may be available for use as well. The memory 730 can include multiple different types of memory with different performance characteristics. It can be appreciated that the example system may operate on a computing device 700 with more than one processor 720 or on a group or cluster of computing devices networked together to provide greater processing capability.

The processor 720 can include any general-purpose processor and a hardware module or software module, such as module 1 762, module 2 764, and module 3 766 stored in storage device 760, configured to control the processor 720 as well as a special-purpose processor where software instructions are incorporated into the processor. The processor 720 may be a self-contained computing system, containing multiple cores or processors, a bus, memory controller, cache, etc. A multi-core processor may be symmetric or asymmetric. The processor 720 can include multiple processors, such as a system having multiple, physically separate processors in different sockets, or a system having multiple processor cores on a single physical chip.

Similarly, the processor 720 can include multiple distributed processors located in multiple separate computing devices, but working together such as via a communications network. Multiple processors or processor cores can share resources, such as memory 730 or the cache 722, or can operate using independent resources. The processor 720 can include one or more of a state machine, an application specific integrated circuit (ASIC), or a programmable gate array (PGA) including a field PGA.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up.

The computing device 700 further includes storage devices 760 or computer-readable storage media such as a hard disk drive, a magnetic disk drive, an optical disk drive, tape drive, solid-state drive, RAM drive, removable storage devices, redundant array of inexpensive disks (RAID), hybrid storage device, or the like. The storage device 760 can include software modules 762, 764, 766 for controlling the processor 720.

The system 700 can include other hardware or software modules. The storage device 760 is connected to the system bus 710 by a drive interface. The drives and associated computer-readable storage devices provide nonvolatile storage of computer-readable instructions, data structures, program modules and other data for the computing device 700. In one aspect, a hardware module that performs a particular function includes the software component stored in a tangible computer-readable storage device in connection with the necessary hardware components, such as the processor 720, bus 710, display 770, and so forth, to carry out a particular function. In another aspect, the system can use a processor and computer-readable storage device to store instructions which, when executed by the processor, cause the processor to perform operations, a method or other specific actions.

The basic components and appropriate variations can be modified depending on the type of device, such as whether the device 700 is a small, handheld computing device, a desktop computer, or a computer server. When the processor 720 executes instructions to perform “operations”, the processor 720 can perform the operations directly and/or facilitate, direct, or cooperate with another device or component to perform the operations.

Although the exemplary computer system 700 employs a hard disk 760, other types of computer-readable storage devices which can store data that are accessible by a computer, such as magnetic cassettes, flash memory cards, digital versatile disks (DVDs), cartridges, random access memories (RAMs) 750, read only memory (ROM) 740, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per sc.

To enable user interaction with the computing device 700, an input device 790 represents any number of input mechanisms. For example, a smart electronic device (smartphone, tablet, PDA and the like) can be accessed using an input device 790 such as a touch screen or pointing device (e.g., a mouse). Functions or outputs graphically shown on an output device 770 can be triggered by a user's finger where the input device 790 is a touch input, or with a cursor when the input device 790 is a mouse, or with the game player's eyes when the input device 790 is an eye tracker. Alternatively, functions or outputs of the system 700 graphically shown on a display can be triggered based on a user's facial or physical expression where the input device 790 is a camera with appropriate gesture tracking technology, with voice when the input device 790 is a microphone with appropriate voice recognition technology, or by thoughts when the input device 790 is a brain-computer interface.

The output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system 700 example is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general-purpose processor. For example the functions of one or more processors presented in FIG. 15 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 740 for storing software performing the operations described below, and random-access memory (RAM) 750 for storing results. Very large-scale integration (VLSI) hardware examples, as well as custom VLSI circuitry in combination with a general-purpose DSP circuit, may also be provided.

The logical operations of the various examples are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 5 can practice all or part of the recited method(s), can be a part of the recited blockchain-based nonprofit exchange 70, and/or can operate according to instructions in the recited tangible computer-readable storage devices. Such logical operations can be implemented as modules configured to control the processor 720 to perform particular functions according to the programming of the module. For example, FIG. 15 illustrates three modules Mod1 762, Mod2 764 and Mod3 766 which are modules configured to control the processor 720. These modules may be stored on the storage device 760 and loaded into RAM 750 or memory 730 at runtime or may be stored in other computer-readable memory locations.

In an example, Mod1 762 may be an ingestion module which ingests the raw phase history of all the relevant pulses from collection of a large area scene. Mod1 764 may be embodied as an enhanced resolution module which enhances the resolution of the relevant pulses ingested from collection of a large area scene. Mod3 766 may be a pixel cleaning module with process the enhanced pulses to create the two-dimensional finished pixel product, that being a two-dimensional scene of complex, grayscale or colorized pixels in either slant or ground plane coordinates.

One or more parts of the example computer system or computing device 700, up to and including the entire computing device 700, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 720 can include all types of processors disclosed herein, including a virtual processor. However, when referring to a virtual processor, the processor 720 includes the software components associated with executing the virtual processor in a virtualization layer and underlying hardware necessary to execute the virtualization layer. The system 700 can include a physical or virtual processor 720 that receive instructions stored in a computer-readable storage device, which cause the processor 720 to perform certain operations. When referring to a virtual processor 720, the system also includes the underlying physical hardware executing the virtual processor 720.

Further, the system 700 of FIG. 15 can also represent a virtual reality device. The device can be a headset that is entirely contained or can include a headset that receives a mobile device such as a Samsung device or an iPhone or other mobile device. In this regard, the features of FIG. 15 can include the components of such a headset. The input device 790 can represent one or more different types of input devices.

The output device 770 can represent a screen through which the user views images. A communication interface 780 can provide a Wi-Fi, or cellular or other wireless communication means with other devices, access points, base stations, and so forth. The adjudication interface 780 may also represent an interface between a removable mobile device and the headset for communicating data between the two components. Memory 730 can represent any standard memory used in the art as well as a secure element which can be used to store information in a secure manner for various uses.

The example method and system are particularly adaptable to large area SAR collections from the moon. Processing of moon data is difficult in that there is a very limited ability to get the data; this is data scarcity. Accordingly, as any pixel processing improvement for raw moon imagery data is a very big deal, the example method and system enables the satellite operator to get as much out of the limited raw moon data as possible.

Accordingly, the example method and system offers a different way to process and clean up large area collection data (e.g., TOPSAR image data collected in IW/EW from SENTINEL-1A and/or Scan mode from ICEYE) that enables the monetization of image data that is typically free on input (but typically not used for dynamic target analysis). The result is a plurality of monetizable pixel outputs of smaller areas that are significantly more useful to the consumer.

The example method and system may provide a number of benefits, one of the most obvious being a massive reduction in both commercial radar and government radar costs. Additionally, use of the method and system may help realize a significant reduction in time between collections, and provide more reliable intelligence from the claimed image data.

Moreover, the example method and system contemplate providing, or otherwise incorporating, additional sensors into the user interface. This means that, in addition to providing a higher quality, pixel product of the existing input raw data (TOPSAR from SENTINEL-1A and/or ICEYE, for example), a satellite vendor could also offer or sell other data sources as well using the same original input. Further, the example method and system allow for the ability to effectively take the original large area/lower resolution SAR image data collection, and process it as a large plurality of smaller but much higher quality images (as to dynamic content) to sell at a fraction of current cost per square kilometer (km²).

Further, the inventive method and system could be applicable to processing of raw phase history data from collections executed using the stripmap/strip modes in both the SENTINEL-1A and ICEYE satellite constellations.

Commercial Applicability. The example embodiments having been described, they offer many potential benefits and advantages over traditional TOPSAR and ScanSAR processing algorithms present in SAR satellite systems in order to measure millimeter-level changes on the Earth's surface on behalf of government and/or large multinational commercial entities. In this commercially-viable example, the example method and system may be applicable to a measurement technique known in the small user community as Interferometric SAR (“InSAR”) in order to substantially reduce cost of higher resolution (higher quality) satellite imagery generated from InSAR analysis for business and governmental purposes.

Since 2007, seven satellites have launched into orbit about the Earth that are capable of creating historical global data stacks for InSAR analysis, with two additional satellite launches expected by the end of 2024. Data providers in many industries use InSAR data to measure small but impactful changes on the ground or surface of the Earth. These measurements may affect the operations of some of the largest and most valuable companies in the world, such as Saudi Aramco, Exxon Mobile, BP, etc., with the energy sector, BHP, Rio Tinto, Glencore, etc. in the mining sector, Allianz, Berkshire Hathaway, MetLife, etc., in the insurance sector, and Maersk, Vitol, Trafigura, etc. in the logistics sector, among other markets.

All of these companies are merely representative of potential customers who may employ the example technology described hereinabove. With the traditional processing approaches described in the background section herein, and in order to meet current minimum customer demands and regulatory requirements, data providers are now required to pay a steep premium for high resolution radar satellite inputs. While medium resolution InSAR inputs are freely available through the European Space Agency (ESA's) Copernicus program, many customers continue to pay, on average, approximately$1,400 per image to provide higher sensitivity satellite-data derived products to their own customers. Though the technology to create dynamic 3D models of Earth is proven, the price point noted above is prohibitive for frequent updates and integration with the measurement tools that inform the decision-making of prospective customers.

The example method and system, on the contrary, offers comparable high quality imagery at a fraction of the price. This is accomplished by fusing collected bursts of free TOPSAR (InSAR) collections to create large synthetic apertures with up to cighty times (80×) the signal content as compared to traditional processing approaches. In other words, at least eighty times (80×) more pulses for a given Sentinel-1A IW collection are processed for enhancement by the example method and system, as compared to a number of pulses processed by a conventional collector in a SAR system.

The example method and system can employ free data sources over land and coastal areas from practically everywhere on Earth with at least a 12-day global revisit, so as to enable global 3D model updates at an affordable price point for widescale adoption.

Researchers have been publishing papers on 3D object reconstruction from 3-5 m pixel resolution imagery (referred to also as “stacks”) for at least a decade. Unfortunately, these stacks require 26 images (at a cost of $31,000 USD per scene) for product generation, and require a lead time of close to three (3) months in order to execute the full order. Conversely, the example method and system enables the creation of these stacks anywhere on Earth with freely available (and free) source input data (as noted above) with the 12-day update period. As such, the example technology could be particularly transformational to exemplary industries such as digital mapping (Google, Meta, Amazon, etc.), telecommunications (AT&T, Verizon, T-Mobile, etc., and mobility (Ford, GM, Toyota, etc.) among many other industries such as infrastructure, commodities, construction, agriculture, satellite operations, and/or to dynamic targets on the ground (defense/intelligence applications).

Existing InSAR data analytics providers have done extensive work building out relationships in many of these market verticals. Yet there are no known companies that have invested in pre-processing techniques to enhance the resolution of free medium resolution collections for high resolution analytics. This opens open a tailor-made audience for the example technology described herein. Namely, as these providers have existing relationships with high-resolution satellite operators, the data sold from use of the example method and system may replace the currently very expensive input data as part of bulk purchase orders.

Additionally, current methods for the creation of global 3D models require months of cloud-free access or 24/7 dedicated satellite tasking. These limitations mean that 3D model updates are available only upon request. In its commercial efforts, Applicant has derived 5 m post-spacing 3D models selling at $3 per km². This is about 5× cheaper than any conventional 3D model currently on the market. Because the source data accessed by Applicant's method and system is free, prices can be adjusted to compete with any new market players.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving case and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A method executed by one or more computing devices in a satellite orbiting the earth for enhancing resolutions of synthetic aperture radar (SAR) collections across a large search area, each collection within the large search area represented by raw phase history data collected across a defined scene within the large search area, the raw phase history data embodied as a plurality of bursts, each burst containing multiple pulses representative of pixel image data, the method comprising:
ingesting a plurality of bursts in the raw phase history collected across each defined scene within the large search area, each ingested burst having a plurality of pulses including clean pulses and additional lower quality noisy pulses that have a determined potential value as to dynamic and stationary information on the ground method dynamic information on the ground,
enhancing resolution of the ingested bursts of clean and additional lower quality noisy pulses to generate enhanced bursts, and
cleaning the enhanced bursts to create a two-dimensional (2D) mosaic scene,
wherein the ingesting, enhancing, and cleaning steps are performed by computer software adapted to run on computer hardware of the one or more computing devices.

2. The method of claim 1, wherein enhancing resolution of the ingested bursts of clean and additional lower quality noisy pulses to generate enhanced bursts further includes subjecting, to a windowing function, the ingested bursts of clean pulses, and ingested additional lower quality noisy pulses determined to contain useful data for enhancing image quality of a final imaging product to be realized, based on a search pattern of an antenna of the SAR, wherein the windowing function processes the ingested bursts on a pixel-by-pixel basis to generate enhanced bursts.

3. The method of claim 1, wherein the created 2D mosaic scene is at a resolution approximating that obtained using a SAR system in high-resolution spotlight mode but is processed at a fraction of the cost typical for high resolution image product from the SAR systems.

4. The method of claim 1, wherein
at least 10% of all pulses in a given burst, including all clean pulses and selected additional lower quality noisy pulses therein, are subject to processing for enhancement in creating the 2D mosaic as the final imaging product, and
at least eighty times (80×) more pulses for a given Sentinel-1A IW collection are processed for enhancement than a number of pulses processed by a conventional collector in a SAR system.

5. The method of claim 1, wherein
a range of at least between 2 and 20 bursts are subject to processing for enhancing resolution in creating the final imaging product, which increases a common dwell time determined for the sequence of pulses to be about 10× to 80× as compared to the common dwell time used in a conventional collector in a SAR system.

6. The method of claim 1, wherein enhancing resolution of the ingested bursts of clean and additional lower quality noisy pulses to generate enhanced bursts further includes:
breaking the defined scene of ingested bursts of clean and additional lower quality noisy pulses into an initial grid, the initial grid embodied by a plurality of overlapping circles, each circle representative of an edge of a conical section of a sphere within the scene to form a localized spherical coordinate system, each circle having a centerpoint that is unique from centerpoints of the other circles,
finding, for the created initial grid, a point closest to the center of the earth that is equidistant to every centerpoint in each circle to determine a time of closest approach (TCA), the TCA used to determine which of the ingested bursts of clean and additional lower quality noisy pulses to include for pixel processing to realize enhanced resolution,
determining a common dwell time to identify those ingested bursts that contribute useful data to enhance image quality, based on a search pattern of the antenna, of a final imaging product that is to be realized as the 2D mosaic scene, any pulses within an ingested burst having no useful data being rejected, the common dwell time being the same for every pixel to be processed,
creating a polar format grid of pixels in the frequency domain from the ingested bursts of clean and additional lower quality noisy pulses identified from the common dwell time as having useful data to enhance image quality, and
subjecting each individual pixel of the polar format grid to a windowing function, wherein each pixel has multiple dominant peaks that are subject to dynamic weighting in the windowing function to generate individual windowed peaks in which unneeded noise signal data has been removed while clarity of the signal data therein is improved, the multiple windowed peaks for each individual pixel summated together as multiple enhanced bursts from the defined scene.

7. The method of claim 1, wherein cleaning the enhanced bursts to create a two-dimensional (2D) mosaic scene further includes:
subjecting each of the enhanced pulses to a common deskew process to generate a plurality of deskewed polar format circles, and
creating the 2D mosaic scene from the plurality of deskewed polar format circles for presentation as a final image product to a consumer.

8. The method of claim 1, wherein the 2D mosaic scene is a scene of complex pixels in either slant coordinates or ground plane coordinates.

9. The method of claim 1, wherein the 2D mosaic scene is a seamless scene of grayscale pixels in either slant coordinates or ground plane coordinates.

10. The method of claim 1, wherein the 2D mosaic scene is a seamless scene of colorized pixels in either slant coordinates or ground plane coordinates.

11. A method for enhancing resolutions of synthetic aperture radar (SAR) collections across a large search area, each collection within the large search area represented by raw phase history data collected across a defined scene within the large search area, the raw phase history data embodied as a plurality of bursts, each burst containing multiple pulses of pixel image data, the method comprising:
ingesting a plurality of bursts in the raw phase history collected across each defined scene, each ingested burst having a plurality of pulses including clean pulses with no noise and additional lower quality noisy pulses having some noise but offering potential value as to stationary or dynamic information on the ground,
subjecting, to a windowing function, the ingested bursts of clean pulses, and the ingested additional lower quality pulses determined to contain useful data for enhancing image quality of a final imaging product to be realized, based on a search pattern of an antenna of the SAR, wherein the windowing function processes the ingested bursts on a pixel-by-pixel basis to generate enhanced bursts, and
cleaning the enhanced bursts to create the final imaging product for a consumer cleaning the enhanced bursts to create a final imaging product for a consumer with enhanced resolution.

12. The method of claim 11, wherein
each burst is a sequence of pulses including primary clean pulses and secondary pulses with noise, and
at least 10% of the pulses in a given burst, including all primary high-quality clean pulses and selected secondary lower-quality noisy pulses therein, are subject to processing for enhancement in creating the 2D mosaic as the final imaging product.

13. The method of claim 11, wherein final imaging product is at least one of a scene of complex pixels in either slant coordinates or ground plane coordinates, a seamless scene of grayscale pixels in either slant coordinates or ground plane coordinates, and a seamless scene of colorized pixels in either slant coordinates or ground plane coordinates.

14. A method for enhancing resolutions of synthetic aperture radar (SAR) collections across a large search area, each collection within the large search area represented by raw phase history data collected across a defined scene within the large search area, the raw phase history data embodied as a plurality of bursts, each burst containing multiple pulses of pixel image data, the method comprising:
applying a sliding polar format algorithm to each of the plurality of bursts to create polar format grids, each burst having a plurality of pulses including clean pulses with no noise and additional lower quality noisy pulses identified in the algorithm as having useful data to enhance image quality,
subjecting the created polar format grids to a windowing function on a pixel-by-pixel basis to generate enhanced bursts, and
cleaning the enhanced bursts to create a final imaging product for a consumer with enhanced resolution.

15. The method of claim 14, wherein
each burst is a sequence of pulses including primary clean pulses and secondary pulses with noise, and
a range of at least between 2 and 20 bursts are subject to processing for enhancing resolution in creating the final imaging product, which increases a common dwell time dwell time determined for the sequence of pulses to be about 2× to 80× as compared to the common dwell time used in a conventional collector in a SAR system.

16. The method of claim 14, wherein the final imaging product is at least one of a scene of complex pixels in either slant coordinates or ground plane coordinates, a seamless scene of grayscale pixels in either slant coordinates or ground plane coordinates, and a seamless scene of colorized pixels in either slant coordinates or ground plane coordinates.

17. A computer system adapted for enhancing resolutions of synthetic aperture radar (SAR) collections across a large search area, each collection within the large search area represented by raw phase history data collected across a defined scene within the large search area, the raw phase history data embodied as a plurality of bursts, each burst containing multiple pulses representative of pixel image data, the computer system comprising:
a processing hardware set, and
a computer-readable storage device medium, wherein the processing hardware set is structured, connected and/or programmed to run program instructions stored on the computer-readable storage medium instructions and associated data, the program instructions including:
an ingestion module programmed to ingest a plurality of bursts in the raw phase history collected across each defined scene within the large search area, each ingested burst having a plurality of pulses including high quality clean pulses and additional lower quality noisy pulses with noise but including data determined useful for enhancing image quality of a final imaging product to be realized,
an enhancement module programmed to enhance resolution of the ingested bursts of clean and additional lower quality noisy pulses to generate enhanced bursts,
a cleaning module programmed to clean the enhanced pulses to create a two-dimensional (2D) mosaic scene as the final imaging product for a consumer, and
a database for storing the created 2D mosaic scene.

18. The computer system of claim 17, wherein the enhancement module is further programmed to subject, to a windowing function, the ingested bursts of clean pulses and those ingested additional lower quality noisy pulses determined to contain useful data for a final imaging product to be realized, based on a search pattern of an antenna of the SAR, wherein the windowing function processes the ingested bursts on a pixel-by-pixel basis to generate the enhanced bursts.

19. The computer system of claim 17, wherein the created 2D mosaic scene is at a resolution approximating that obtained using a SAR system in high-resolution spotlight mode but is processed at a fraction of the cost typical for high resolution image product from the SAR systems.

20. The computer system of claim 17, wherein the created 2D scene serving as the final imaging product is at least one of a scene of complex pixels in either slant coordinates or ground plane coordinates, a seamless scene of grayscale pixels in either slant coordinates or ground plane coordinates, and a seamless scene of colorized pixels in either slant coordinates or ground plane coordinates.
